(19) United States
(12) Patent Application Publication
(10) Pub. No.: US 2010/0269038 A1
(43) Pub. Date: Oct. 21, 2010

(54) Variable Rate Scrolling

(75) Inventor: Takamoto Tsuda, Malmo (SE)

Correspondence Address: SNYDER, CLARK, LESCH & CHUNG, LLP, 950 Herndon Parkway, Suite 365, HERNDON, VA, 20170, US

(73) Assignee: SONY ERICSSON MOBILE COMMUNICATIONS AB, Lund (SE)

(21) Appl. No.: 12/425,665

(22) Filed: Apr. 17, 2009

(51) Int. Cl. G06F 3/01; G06F 3/048

(52) U.S. Cl. 715/702; 715/784

(57) ABSTRACT

A method may include outputting, to a display, at least a portion of a number of items. The method may also include receiving a first user input via the display and identifying a location on the display corresponding to the first user input. The method may further include determining a scroll rate associated with the location and scrolling, via the display, the plurality of items at the determined scroll rate.

### TECHNICAL FIELD OF THE INVENTION

The invention relates generally to displays and, more particularly, to interacting with a display.

### DESCRIPTION OF RELATED ART

Computer, communication and entertainment devices, such as personal computers (PCs), lap top computers, mobile terminals, personal digital assistants (PDAs), music playing devices, etc., often output a long list of items from which a user may make a selection. For example, a portable music playing device may store hundreds or thousands of songs. The display screen of these devices, however, is often quite small. Therefore, the list of songs from which a user may select a song for playing often exceeds the display capability of the device. Typically, these devices allow the user to scroll through the list in order to view items not currently being displayed.

### SUMMARY

According to one aspect, a device is provided. The device includes a touch screen display configured to display at least a portion of a plurality of items and receive a first user input. The device also includes display configuration logic configured to configure the touch screen display to include at least two regions, where each of the at least two regions is associated with a different scroll rate for scrolling the plurality of items, and provide a visual indicator on the touch screen display, where the visual indicator identifies a relative scroll rate associated with the at least two regions. The device further includes display control logic configured to identify a location on the touch screen display corresponding to the first user input, and control the scroll rate of the plurality of items based on the location.

Additionally, when controlling the scroll rate, the display control logic may be configured to scroll the plurality of items, via the touch screen display, at a first rate when the identified location corresponds to a first location, and scroll the plurality of items, via the touch screen display, at a second rate when the identified location corresponds to a second location, wherein the second scroll rate is faster than the first scroll rate.

Additionally, when providing a visual indicator, the display configuration logic may be configured to provide at least one of a plurality of colors or a plurality of brightness levels associated with a background of the touch screen display to indicate a relative scroll rate associated with each of the at least two regions.

Additionally, when providing a visual indicator, the display configuration logic may be configured to provide at least one of a shape, a line or a graphical icon to indicate a relative scroll rate associated with each of the at least two regions.

Additionally, the touch screen display may be further configured to receive a second user input, and wherein the display control logic is further configured to change the scroll rate for scrolling the plurality of items based on a location of the second user input.

Additionally, when the second user input is located in a same one of the at least two regions as the first user input, the display control logic may be further configured to increase the scroll rate associated with scrolling the plurality of items.

Additionally, the display configuration logic may be configured to provide a graphical user interface (GUI) configured to allow the user to at least one of select the at least two regions associated with different scroll rates, or select the visual indicator for identifying the relative scroll rate associated with the at least two regions.

Additionally, the GUI may be further configured to allow the user to at least one of select types of scrolling associated with different types of user inputs, or select how scrolling rates will be modified for an input provided subsequent to the first user input.

Additionally, the display control logic may be further configured to scroll, via the touch screen display, the plurality of items in response to the first user input, and continue to scroll the plurality of items until a subsequent user input is detected.

Additionally, the device may comprise a mobile terminal.

According to another aspect, a method is provided. The method includes outputting, to a display, at least a portion of a plurality of items, receiving a first user input via the display and identifying a location on the display corresponding to the first user input. The method also includes determining a scroll rate associated with the location and scrolling, via the display, the plurality of items at the determined scroll rate.

Additionally, the determining a scroll rate may include determining a first scroll rate when the identified location corresponds to a first location, and determining a second scroll rate when the identified location corresponds to a second location, wherein the second scroll rate is faster than the first scroll rate.

Additionally, the method may further comprise providing, via the display, a visual indicator identifying relative scroll rates associated with different portions of the display for scrolling the plurality of items.

Additionally, the providing a visual indicator may comprise at least one of providing a color indicator or a brightness indicator to indicate relative scroll rates associated with the different portions of the display.

Additionally, the providing a visual indicator may comprise at least one of providing a shape, a line or a graphical icon to indicate a relative scroll rate associated with the different portions of the display.

Additionally, the method may further comprise receiving user preference information associated with configuring regions of the display to correspond to different scroll rate input regions, and receiving user preference information associated with providing a visual indicator associated with the different scroll rate input regions.

Additionally, the method may further comprise receiving user preference information associated with identifying different types of user inputs provided via the display, wherein the different types of user inputs include at least two of a touch, a flicking motion or a dragging motion, identifying a type of user input corresponding to the first user input, and scrolling the plurality of items based on the identified type of user input.

According to a further aspect, a computer-readable medium having stored thereon sequences of instructions is provided. The instructions, when executed by at least one processor, cause the at least one processor to output, to a display, at least a portion of a plurality of items of interest and receive, from the display, a first user input. The instructions also cause the at least one processor to identify a location on the display corresponding to the first user input, determine a scroll rate associated with the location, and scroll, via the display, the plurality of items of interest at the determined scroll rate.

Additionally, the instructions for scrolling the plurality of items of interest may cause the at least one processor to scroll, via the display, the plurality of items of interest at a first scroll rate when the identified location corresponds to a first side of the display, and scroll, via the display, the plurality of items of interest at a second scroll rate when the identified location corresponds to a second side of the display, wherein the second scroll rate is faster than the first scroll rate.

Additionally, the computer-readable medium may further include instructions for causing the at least one processor to provide a graphical user interface configured to receive user preference information for selecting regions corresponding to different scroll rates, and receive user preference information for selecting a visual indicator for indicating different relative scroll rates associated with the regions.

### BRIEF DESCRIPTION OF THE DRAWINGS

Reference is made to the attached drawings, wherein elements having the same reference number designation may represent like elements throughout.

FIG. 1 is a diagram of an exemplary device in which methods and systems described herein may be implemented;

FIG. 2 is a functional block diagram of exemplary components implemented in the device of FIG. 1;

FIG. 3 is a block diagram of components implemented in the device of FIG. 2 according to an exemplary implementation;

FIG. 4 is a flow diagram illustrating exemplary processing associated with configuring scrolling related parameters for the user device of FIG. 1;

FIGS. 5A-5C are diagrams of exemplary displays associated with configuring scrolling related parameters associated with the processing of FIG. 4;

FIG. 6 is a flow diagram illustrating exemplary processing associated with scrolling information provided on the user device of FIG. 1; and

FIGS. 7A-9B are diagrams of exemplary displays associated with the processing described in FIG. 6.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

### Exemplary System

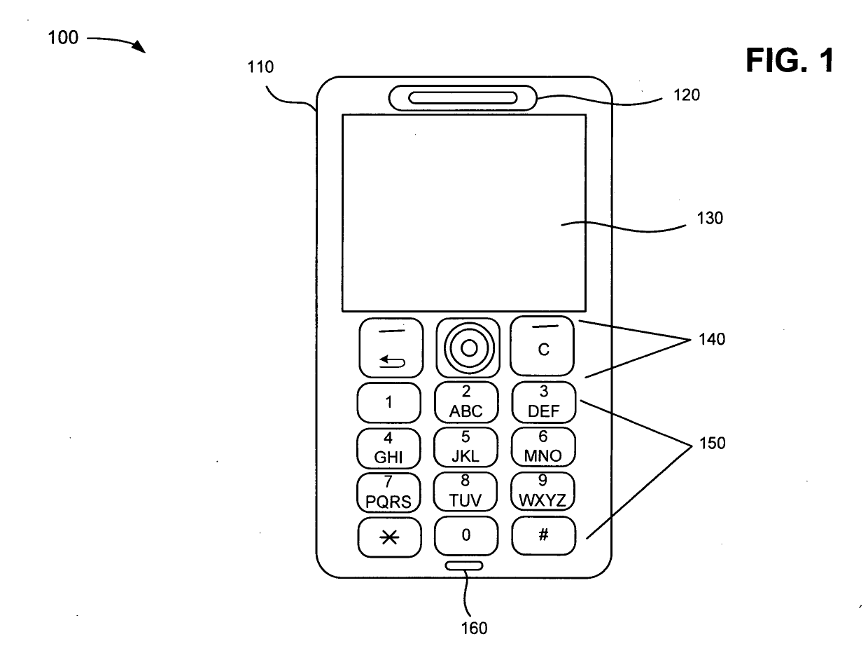

FIG. 1 is a diagram of an exemplary user device 100 in which methods and systems described herein may be implemented. In an exemplary implementation, user device 100 may be a mobile terminal. As used herein, the term “mobile terminal” may include a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices. It should also be understood that systems and methods described herein may also be implemented in other devices that display information of interest and allow users to interact with the displayed information with or without including various other communication functionality. For example, user device 100 may include a personal computer (PC), a laptop computer, a personal digital assistant (PDA), a media playing device (e.g., an MPEG audio layer 3 (MP3) player, a video game playing device), a global positioning system (GPS) device, etc., that may not include various communication functionality for communicating with other devices.

Referring to FIG. 1, user device 100 may include a housing 110, a speaker 120, a display 130, control buttons 140, a keypad 150, and a microphone 160. Housing 110 may protect the components of user device 100 from outside elements. Speaker 120 may provide audible information to a user of user device 100.

Display 130 may provide visual information to the user. For example, display 130 may provide information regarding incoming or outgoing telephone calls, electronic mail (e-mail), instant messages, short message service (SMS) messages, etc. Display 130 may also display information regarding various applications, such as a phone book/contact list stored in user device 100, the current time, video games being played by a user, downloaded content (e.g., news or other information), etc. Display 130 may also display various lists, such as a list of songs stored in user device 100, a list of web sites resulting from a web search, a list of locations resulting from a GPS search, a list of contacts, a list of applications stored on user device 100, or any type of list from which a user may make a selection. In an exemplary implementation, display 130 may be a touch screen display device that allows a user to enter commands and/or information via a finger, a stylus, a mouse, a pointing device, or some other device. For example, display 130 may be a resistive touch screen, a capacitive touch screen, an optical touch screen, an infrared touch screen, a surface acoustic wave touch screen, or any other type of touch screen device that registers an input based on a contact with the screen.

Control buttons 140 may permit the user to interact with user device 100 to cause user device 100 to perform one or more operations, such as place a telephone call, play various media, etc. In an exemplary implementation, control buttons 140 may include one or more buttons that controls various applications associated with display 130. For example, one or more of control buttons 140 may be used to initiate execution of an application program that permits a user to configure options associated with displaying and scrolling information provided on display 130, as described in detail below.

Keypad 150 may include a standard telephone keypad. Microphone 160 may receive audible information from the user for activating applications or routines stored within user device 100.

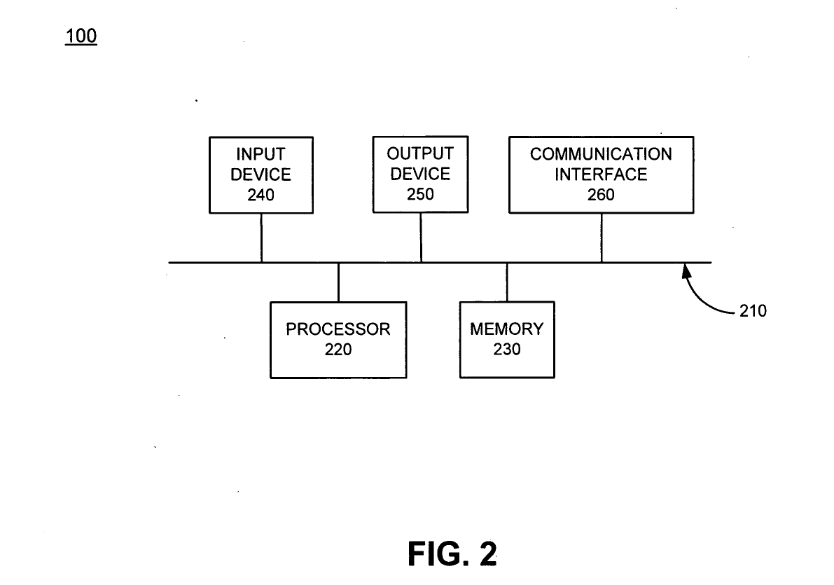

FIG. 2 is a diagram illustrating components of user device 100 according to an exemplary implementation. User device 100 may include bus 210, processor 220, memory 230, input device 240, output device 250 and communication interface 260. Bus 210 permits communication among the components of user device 100. One skilled in the art would recognize that user device 100 may be configured in a number of other ways and may include other or different elements. For example, user device 100 may include one or more modulators, demodulators, encoders, decoders, etc., for processing data.

Processor 220 may include a processor, microprocessor, an application specific integrated circuit (ASIC), field programmable gate array (FPGA) or other processing logic. Processor 220 may execute software instructions/programs or data structures to control operation of user device 100.

Memory 230 may include a random access memory (RAM) or another type of dynamic storage device that stores information and instructions for execution by processor 220; a read only memory (ROM) or another type of static storage device that stores static information and instructions for use by processor 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processor 220. Instructions used by processor 220 may also, or alternatively, be stored in another type of computer-readable medium accessible by processor 220. A computer-readable medium may include one or more memory devices.

Input device 240 may include mechanisms that permit an operator to input information to user device 100, such as microphone 160, keypad 150, control buttons 140, a keyboard (e.g., a QWERTY keyboard, a Dvorak keyboard, etc.), a gesture-based device, an optical character recognition (OCR) based device, a joystick, a touch-based device, a virtual keyboard, a speech-to-text engine, a mouse, a pen, voice recognition and/or biometric mechanisms, etc. In an exemplary implementation, display 130 may be a touch screen display that acts as an input device.

Output device 250 may include one or more mechanisms that output information to the user, including a display, such as display 130, a printer, one or more speakers, such as speaker 120, etc. As described above, in an exemplary implementation, display 130 may be a touch screen display. In such an implementation, display 130 may function as both an input device and an output device.

Communication interface 260 may include any transceiver-like mechanism that enables user device 100 to communicate with other devices and/or systems. For example, communication interface 260 may include a modem or an Ethernet interface to a LAN. Communication interface 260 may also include mechanisms for communicating via a network, such as a wireless network. For example, communication interface 260 may include one or more radio frequency (RF) transmitters, receivers and/or transceivers and one or more antennas for transmitting and receiving RF data via a network.

User device 100 may provide a platform for a user to send and receive communications (e.g., telephone calls, electronic mail, text messages, multi-media messages, short message service (SMS) messages, etc.), play music, search the Internet, or perform various other functions. User device 100, as described in detail below, may also perform processing associated with allowing a user to set various display related parameters associated with scrolling information output to display 130. User device 100 may perform these operations in response to processor 220 executing sequences of instructions contained in a computer-readable medium, such as memory 230. Such instructions may be read into memory 230 from another computer-readable medium via, for example, and communication interface 260. In alternative embodiments, hard-wired circuitry may be used in place of or in combination with software instructions to implement processes consistent with the invention. Thus, implementations described herein are not limited to any specific combination of hardware circuitry and software.

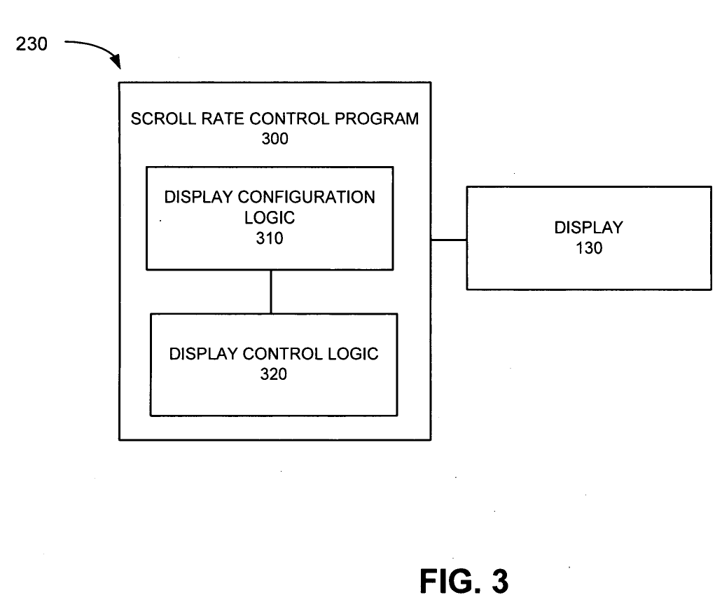

FIG. 3 is an exemplary block diagram of components implemented in user device 100 of FIG. 2. In an exemplary implementation, all or some of the components illustrated in FIG. 3 may be stored in memory 230. For example, referring to FIG. 3, memory 230 may include scroll rate control program 300.

Scroll rate control program 300 may include a software program executed by processor 220 that allows a user to set various scrolling related parameters associated with information provided on display 130, such as lists of information that may not be viewed in their entirety at one time on display 130. Display configuration logic 310 may include logic to allow a user to select a particular configuration or set a user profile with respect to scrolling a list of items provided on display 130. For example, display configuration logic 310 may provide a graphical user interface (GUI) output to display 130 that allows a user to select one portion of display 130 as an area in which a user may provide an input that results in a very fast scrolling of a list of items output on display 130 and to select another portion of display 130 as an area in which the user may provide an input that results in a slower scrolling of the list of items output on display 130. In addition, the GUI may allow a user to select various types of display indicators that will be used to identify slower or faster scroll areas with respect to scrolling a list of items, as described in detail below. In some implementations, the GUI may also allow a user to select how multiple user inputs can be used to affect the scrolling rate, as also described in detail below.

Display control logic 320 may include logic that controls display 130 based on various scrolling related parameters stored in display configuration logic 310. These scrolling related parameters may include parameters provided by the user via display configuration logic 310 (e.g., the GUI described above). For example, display control logic 320 may control display 130 to scroll a list of displayed items at a first speed, based on a location of a touch on display 130, and scroll a list of display items at a different speed based on a different location of a touch on display 130, as described in more detail below.

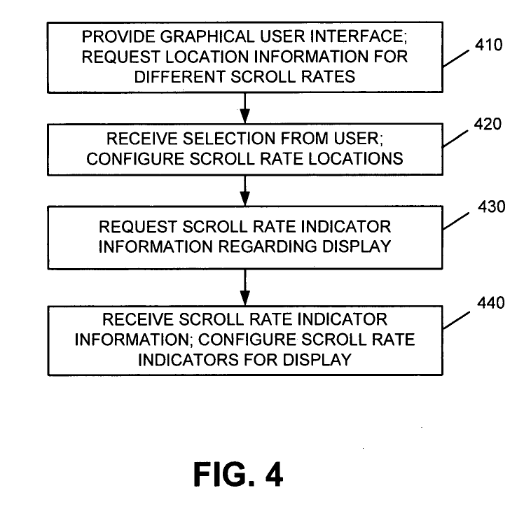

FIG. 4 illustrates exemplary processing associated with configuring various scrolling related parameters with respect to display 130. Processing may begin with a user of user device 100 accessing scroll rate control program 300. For example, a user of user device 100 may launch scroll rate control program 300 using one or more of control buttons 140 and/or an applications menu. Scroll rate control program 300, as described above, may include display configuration logic 310 that includes a GUI that allows a user to set up or customize various locations on display 130 that will implement different scrolling speeds. In one implementation, the GUI associated with display configuration logic 310 may output an inquiry on display 130 inquiring whether the user would like to set areas on display 130 that will result in different scrolling rates (act 410).

For example, the GUI may inquire as to whether the user would like to have one portion of display 130 be associated with a normal/slow rate of scrolling, and another portion of display 130 be associated with a fast scrolling rate (act 410). As one example, the GUI may inquire whether the user would like for the left hand side of display 130 to be associated with a slow scrolling rate and the right hand side of display 130 to be associated with a fast scrolling rate. Assume that the user of user device 100 inputs an affirmative response. Display configuration logic 310 receives the user's selection and stores the selection (act 420).

In the example above, the user selected two areas of display 130 to represent different scroll rate input areas. In other instances, the GUI provided by display configuration logic 310 may provide any number of other customizable options with respect to setting different areas on display 130 that will be associated with different scrolling rates. For example, the user may select three separate areas (e.g., left side, middle, right side) to be associated with three different scroll rates (e.g., slow, medium, fast). The user may alternatively select a top portion of display 130 to be associated with one scrolling rate and the bottom portion of display 130 to be associated with a different scrolling rate.

In each case, assume that the user interacts with the GUI and provides his/her preference(s) with respect to different scroll rates on different portions of display 130. Display configuration logic 310 receives the user-provided information. Display configuration logic 310 may store the user's preferences and use the stored information to configure display 130 based on the user's preferences (act 420). For example, assume that the user requested that the left half of display 130 corresponds to slow/normal speed scrolling and that the right half of display 130 corresponds to fast scrolling. In this case, display configuration logic 310 may store information indicating that an input (associated with scrolling a list) on the left hand side of display 130 will result in a slow/medium scrolling rate, while an input on the right hand side of display 130 will result in fast scrolling rate.

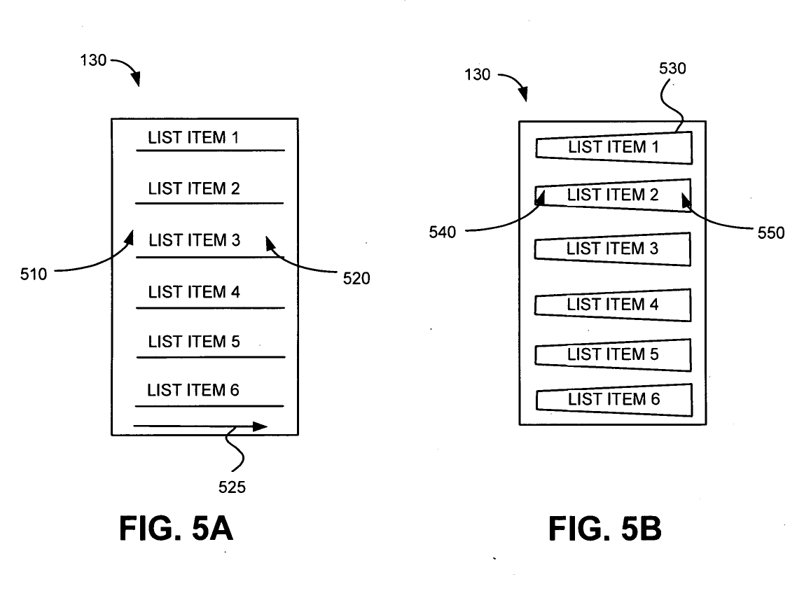

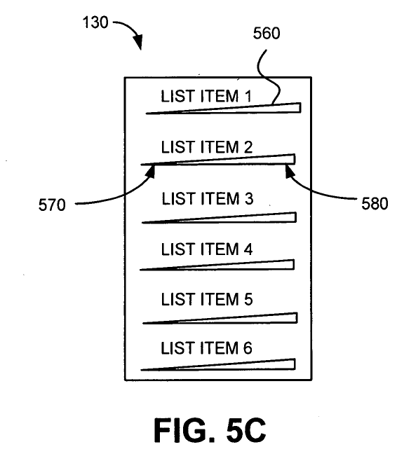

The GUI provided by display configuration logic 310 may also inquire as to the type of indicator the user would like to provide on display 130 as an indication of the different scrolling rate input areas (act 430). For example, the GUI may inquire whether the user would like to use color or color gradation to visually indicate the different scroll rate input areas. In this instance, the background color of display 130 may be one color in a fast scrolling input area and another color in a slower scrolling input area. For example, FIG. 5A illustrates display 130 providing a list of items (labeled list items 1 through 6) from which a user may select. As discussed above, a list may often include more items than can be displayed at one time on display 130. In this example, assume that the list of items includes 100 items, of which only six can be displayed at any one time on display 130. Continuing with the example above in which the left side of display 130 is associated with a slower scrolling speed than the right side of display 130, the left hand side of display at area 510 may have a background color that is different than the background color of area 520. For example, the background color at area 510 may be a light yellow or pale green, where the background color at area 520 may be a darker yellow or darker green. In this case, the user may have selected colors or color gradation to use as an indicator of scrolling rate. That is, the color or hue of the background may vary from the left side of display 130 to the right side of display 130 in either a gradual manner or in a discrete manner. In one example, the paler or less intense color may correspond to a slower scrolling rate and the richer or more intense color may correspond to a faster scrolling rate. In some instances, the user may select multiple colors or a spectrum of colors to indicate the different scroll rates associated with locations on display 130. Further, in some instances, an arrow 525 located at the bottom of display 130 may indicate that scroll speed increases from left to right. In some instances, arrow 525 may be labeled “scroll speed” or something similar to indicate that the scroll speed is greater with respect to inputs made on the right side of display 130 as compared to inputs made on the left side of display 130.

In other instances, the user may select brightness of the background of display 130 to be the visual indicator used to indicate the scrolling rate. For example, the brightest area of the background of display 130 may correspond to the fastest scroll rate and the lightest area may correspond to the slowest scroll rate. Again, the background brightness of display 130 may be continuous in nature or in discrete increments.

In still other instances, the user may select the shape of a frame or box encompassing the listed items to be used as an indicator of scroll rate. For example, referring to FIG. 5B, each listed item on display 130 may be framed by a box 530 (also referred to as frame 530). As illustrated, the left side 540 of each frame 530 may be narrower than the right side 550 of each frame 530. The narrower side 540 may be used to indicate a slower scroll rate than the wider side 550. That is, a user may provide an input on the narrower side 540 of frame 530 to scroll at a slow rate and provide an input on the wider side 550 of frame 530 to scroll at a fast rate.

As still another example, the user may select the shape of the line between items to be used to indicate the scrolling rate. For example, referring to FIG. 5C, each list item on display 130 may include a separating line/shape 560 that separates one item from the next item. As illustrated, the left side 570 of line/shape 560 is very thin and the right side 580 is much thicker or wider. The narrower side 570 of line 560 may be used to indicate a slower scroll rate than the wider side 580. That is, a user may provide an input on narrower side 570 of line 560 to scroll at a slow rate and provide an input on wider side 580 of line 560 to scroll at a fast rate.

In some implementations, the user may select different scroll rate indicators based on the particular type of items being displayed. For example, the scroll rate indicator lines 560 illustrated in FIG. 5C may be selected as a scroll rate indicator for scrolling a list of song titles since the scroll rate indicator lines/shapes 560 resemble a volume bar, while background color may be used to indicate different scroll rates for a list of contacts in an address book.

In each case, assume that the user selects his/her preferences with respect to providing a scroll rate indicator. Display configuration logic 310 receives the information from the user and stores the user preference(s) (act 440). Display configuration logic 310 may then configure display 130 based on the user's preferences. That is, display configuration logic 310 may configure display 130 to output the user-selected visual scroll rate indicator on display 130 when a list of items is output to display 130 (act 440).

In some implementations, the GUI provided by display configuration logic 310 may allow a user to set other scrolling related parameters. For example, the GUI may allow the user to select options for further increasing or decreasing the scroll rate by providing successive inputs on a portion of display 130. For example, referring to FIG. 5A, the GUI may allow a user to indicate that a second input on, for example, the right side 520 of display 130 (after an initial input on right side 520) may further increase the fast scroll rate by some relative predetermined amount (e.g., 25% increase in scroll rate, 50% increase in scroll rate, etc.). Similarly, a second input on, for example, the left side 510 (after an initial input on left side 510) may slow the scroll rate by some relative predetermined amount (e.g., 25%, 50%, etc.).

The GUI may also allow a user to select options indicating that particular types of inputs may correspond to continuous scrolling as opposed to scrolling a predetermined number of items in the list. For example, the GUI may allow a user to select that a particular type of input, such as a “flicking” motion, may correspond to a continuous scroll, while a single tap/touch or a dragging input may correspond to scrolling a predetermined number of entries. Further, the user may select, for example, that multiple taps or touches in a particular area will correspond to continuous scrolling. In this manner, the user may customize scrolling related parameters based on his/her preferences.

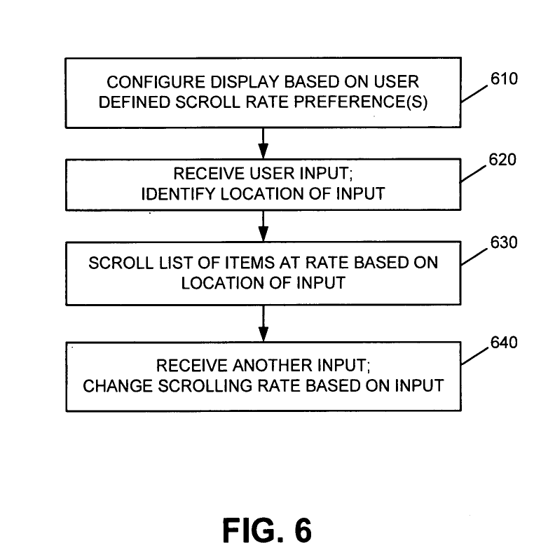

FIG. 6 is a flow diagram illustrating exemplary processing associated with scrolling information output on display 130. Processing may begin with a user performing a search of items that may be stored on user device 100. For example, assume that the user of user device 100 retrieves a list of songs stored in memory 230. Further assume that the list of songs includes 150 songs and that only six songs can be displayed at one time on display 130. Display configuration logic 310 may configure display 130 based on the user defined preferences (act 610). For example, as described above with respect to FIG. 4, assume that the user selected that the right side of display 130 will correspond to a fast scroll rate input area and that the left side of display 130 will correspond to a slow/medium scroll rate input area. Further assume that the user selected background brightness as a scroll rate indicator.

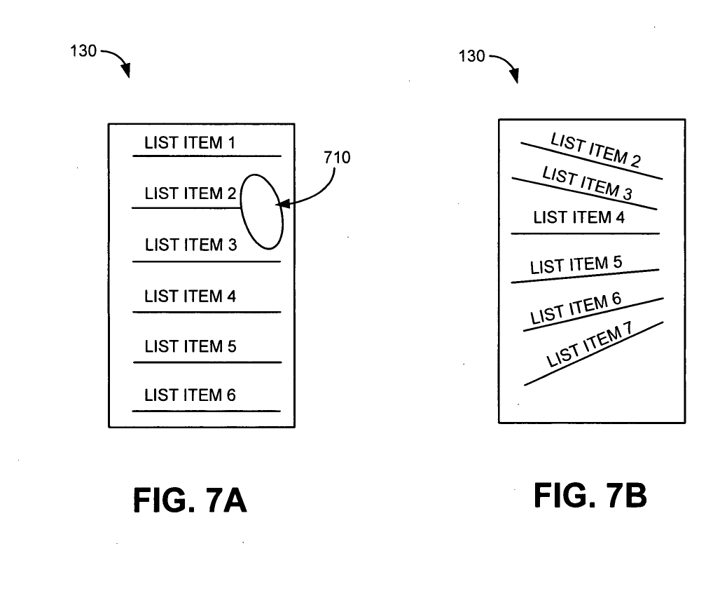

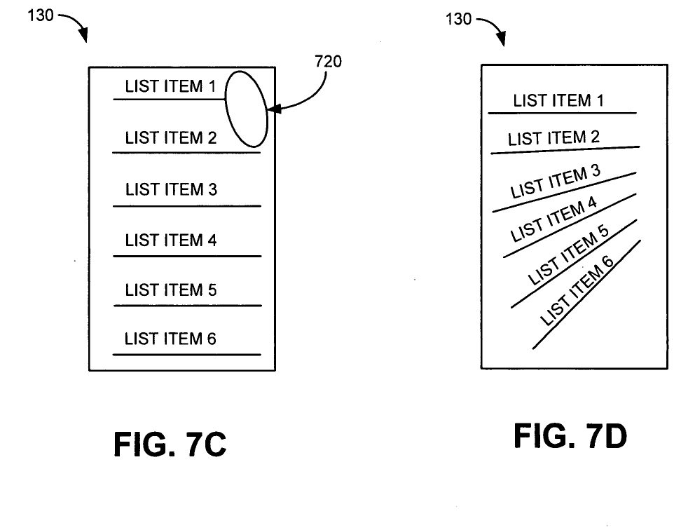

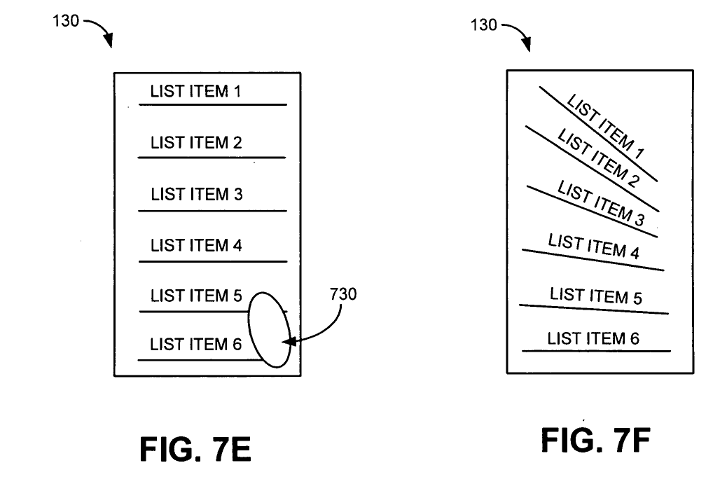

In each case, display configuration logic 310 configures display 130 based on the user defined preferences. That is, in this example, the background of the right side of display 130 will be brighter than the left side of display 130, which will indicate that an input on the right side of display 130 will result in a faster scrolling rate than an input on the left side of display 130. Further assume that the user would like to quickly scroll the list of items on display 130. Continuing with the example above, assume that the user touches the right hand side of display 130 (act 620). For example, assume that the user touches his/her finger on the right hand side of display 130, as illustrated by oval 710 in FIG. 7A. Display control logic 320 may identify the location of the input (act 620). Display control logic 320 may also correlate the location of input 710 to a scroll rate stored in display configuration logic 310 and scroll the list of items based on the identified scroll rate (act 630). In this example, display control logic 320 may scroll the list of items at a fast rate.

FIG. 7B illustrates an exemplary view of display 130 after the user has selected to scroll at a fast rate. As illustrated in FIG. 7B, list item 1 is no longer visible and list item 7 is shown as the list begins to scroll from list items 7 through the end of the list. In one implementation, as illustrated in FIG. 7B, display 130 may optionally provide a visual effect when the items are being scrolled that appears as though the list of items is moving in a large circle as they are being scrolled. In other implementations, the scrolled list of items may be scrolled in a more vertical manner where each item that is no longer visible is replaced by a new item in the list. In an exemplary implementation, once the user provides an input at area 710, the list may scroll in a continuous manner until the user selects a stop button/input (not shown in FIG. 7A) or selects one of control buttons 140 (FIG. 1) to stop the scrolling. In other instances, once the user provides an input at area 710, the list may scroll through a predetermined portion of the list and automatically stop.

In an exemplary implementation, the visual transition of display 130, after a user has provided an input, may be focused at the location of the touch area. For example, FIG. 7C illustrates display 130 that is displaying a list of six items. Assume that the user touches his/her finger, a stylus or some other device on the upper right portion of display 130, as illustrated by oval 720 in FIG. 7C. Similar to the discussion above with respect to FIG. 7A, display control logic 320 may correlate the location of input 720 to a scroll rate stored in display configuration logic 310 and scroll the list of items based on the identified scroll rate. In this implementation, the visual transition associated with the scrolling of display 130 may focus on the upper right corner of display 130, as illustrated in FIG. 7D. That is, the scrolling list of items output to display 130 will be focused on the upper right corner of display 130, such that it appears that the scrolling is being performed about or originated from the upper right hand portion of display 130. For example, display 130 provides a visual effect that the upper right hand corner of display 130 is the focal point of a large circle of items that are moving about the upper right hand corner.

To further illustrate this visual effect, assume that the user touches his/her finger, a stylus or some other device on the lower right portion of display 130, as illustrated by oval 730 in FIG. 7E. Similar to the discussion above with respect to FIG. 7A, display control logic 320 may correlate the location of input 730 to a scroll rate stored in display configuration logic 310 and scroll the list of items based on the identified scroll rate. In this implementation, the visual transition associated with the scrolling of display 130 may focus on the lower right corner of display 130, as illustrated in FIG. 7F. That is, the scrolling list of items output to display 130 will be focused on the lower right corner of display 130, such that it appears that the scrolling is being performed about or originated from the lower right hand portion of display 130. That is, display 130 provides a visual effect that the lower right hand corner of display 130 is the focal point of a large circle of items that are moving.

In some instances, the element located at the focal point of the scrolling list may be more easily read while the scrolling is occurring. For example, in FIG. 7D, list item 1 (or other items located in the upper right portion of display 130) may be displayed in a horizontal manner that may be more easily read as the scrolling is occurring than items displayed in other portions of display 130 (e.g., items displayed in the lower portion of display 130). Similarly, in FIG. 7F, list item 6 (or other items located in the lower right portion of display 130) may be displayed in a horizontal manner and may be more easily read than items displayed in other portions of display 130 (e.g., items displayed in the upper portion of display 130).

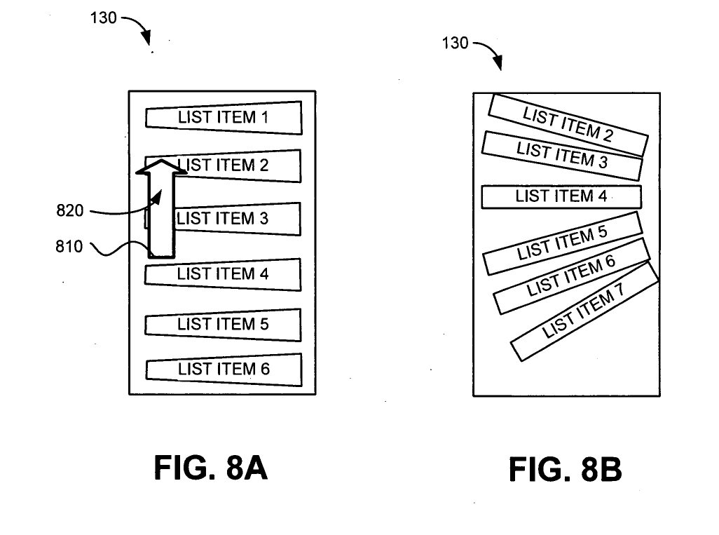

As described above, in some implementations, display 130 may be configured to allow a user to simply provide an input with his/her finger, a stylus, a mouse, a pointing device, or some other device to initiate a scrolling action on display 130. In other implementations, the user may provide a flicking motion input on display 130 to initiate a scrolling action. For example, referring to FIG. 8A, the user may touch his/her finger or a stylus at point 810 on display 130 and initiate a flicking motion on the surface of display 130 in the direction represented by arrow 820. In this instance, display control logic 320 may identify the initial location 810 associated with the “flick” as corresponding to a slow scroll rate. Display control logic 320 may also identify the direction of the flick and scroll the list of items using a slow scroll rate in a direction corresponding to arrow 820. FIG. 8B illustrates a slow scroll in the direction represented by arrow 820. As illustrated in FIG. 8B, in one implementation, the items in the list may be scrolled to create a visual effect that the list of items are scrolling in a circular motion to present an interesting visual effect. In other instances, the items may be scrolled in a more vertical manner (e.g., the items simply move in the vertical direction represented by arrow 820 to display new items located lower on the list).

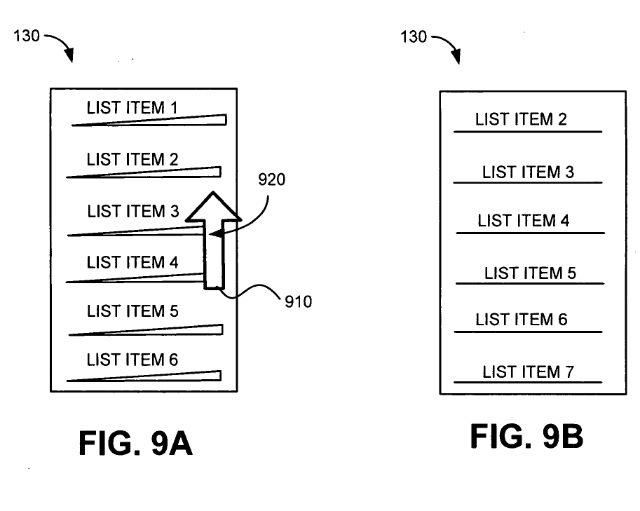

In still other instances, the user may use a dragging motion on display 130 to initiate a scrolling action. For example, referring to FIG. 9A, the user may touch his/her finger on display 130 at area 910 and drag his/her finger on the surface of display 130 in the direction illustrated by arrow 920. In this instance, display control logic 320 may identify the location of input 910 as corresponding to a fast scroll rate. Display control logic 320 may also identify the direction of the dragging input represented by arrow 920 and scroll the list in the direction illustrated in FIG. 9B (i.e., display items located lower in the list of items).

In each case, the user may scroll a list of items output to display 130 at different rates based on where the user provides his/her input on display 130. In addition, the user may use any number of different types in inputs to initiate the scrolling. For example, the user may use his/her finger, a stylus, a mouse, a pointing device, or any other device to initiate a scrolling action with respect to display 130. Further, the user may use different types of motions (e.g., touch, dragging, flicking, etc.) to initiate a scrolling action. In addition, as described above, in some implementations, display control logic 320 may determine whether to perform a continuous scroll or scroll a predetermined number of entries based on the type of motion.

As also described above, in some implementations, display 130 may be configured to allow the user to further increase or decrease the speed at which the list is scrolled based on additional inputs provided by the user. For example, assume that the user has set a preference (using the GUI associated with display configuration logic 310) that a subsequent input on a fast scroll input area after a fast scroll has been initiated will further increase the scroll rate. Further assume that the user has set a preference that a subsequent input on a slow scroll input area after a slow scroll has been initiated will further decrease the scroll rate. In this case, referring back to FIG. 7A, assume that the user has initially touched area 710 to initiate a fast scroll of the list of items. Further assume that the user touches area 710 again or touches any area on the right side of display 130 (FIG. 6, act 640). In this case, display control logic 320 may further increase the rate of scrolling of the list of items (act 640). For example, a second user input in the fast scrolling area may increase the scrolling rate some predetermined amount (e.g., 25%) as compared to the initial “fast” scrolling rate. Subsequent user inputs may further increase the scrolling rate by some predetermined amount in a similar manner until a maximum scroll rate is reached. Similarly, touching the left side of display 130 may incrementally reduce the rate of scrolling with each successive touch by a predetermined amount.

In still other implementations, a user may dynamically increase or decrease the rate or speed at which a list is being scrolled by dragging or flicking his/her finger, stylus, or other pointing device from an input area having a first scroll rate to an input area having a different scroll rate. For example, in FIG. 5B, assume that user drags his/her finger from a slow scroll rate input area 540 on the left side of display 130 to a fast scroll rate input area 550 on the right side of display 130. In this case, the scroll rate may dynamically increase from slow to fast. That is, the scroll rate may change while the scrolling is occurring. Similarly, the user may drag his/her finger from input area 550 to input area 540 to dynamically reduce the scroll rate.

In this manner, the user may scroll a list of items using variable scroll rates. The user may also switch between providing inputs on fast and slow scroll rate input areas to vary the rate at which the items are scrolled. When the user wishes to stop scrolling, the user may select a stop input (not shown in FIGS. 7A-9B) or select a particular one of control buttons 140 (FIG. 1) to stop scrolling. In other implementations, each input used to initiate a scrolling of a list may scroll through a predetermined number of items and automatically stop scrolling after the predetermined number has been reached.

### CONCLUSION

Implementations described herein allow a user to scroll items provided on a display at various rates. This may allow a user to more easily scroll and locate items of interest. In addition, visual effects may be provided to allow the user to easily ascertain that various input areas on the display will result in different scrolling rates. This further enhances the user's experience with respect to scrolling items of interest.

The foregoing description of the embodiments described herein provides illustration and description, but is not intended to be exhaustive or to limit the invention to the precise form disclosed. Modifications and variations are possible in light of the above teachings or may be acquired from the practice of the invention.

For example, aspects have been described above with respect to setting discrete, relative scroll rates (e.g., slow, medium, fast). In some implementations, the scroll rate may be continuous in nature. For example, in some implementations the rate or speed at which a list of items is scrolled may increase in a more continuous manner based on the user-defined preferences. In such implementations, a large number of different scrolling rates may be provided based on the location on display 130 at which an input is provided. As an example, a input on the left most side of display 130 may result in the slowest scroll rate, an input adjacent the left most side of display 130 may result in a slightly faster scroll rate, etc., up through an input on the right most side of display 130 that may result in the fastest scroll rate.

Further, aspects described above refer to setting user-defined preferences with respect to scrolling items of interest. In other instances, user device 100 may include pre-set configurations with respect to scrolling items of interest and/or providing visual indicators of scrolling rates. In such instances, a user may simply use default configurations pre-stored in user device 100 with respect to variable rate scrolling.

In addition, examples have been provided that illustrate scrolling lists of items that may be listed in a row-by-row manner. It should be understood that in other instances, items may be displayed in columns and scrolling may be performed in a horizontal direction with respect to display 130 (as opposed to the vertical direction illustrated in the examples). In still other instances, items of interest, such as icons associated with various applications stored on user device 100, may be displayed in a grid-like manner. In these instances, scrolling the icons in the grid-like display may be performed in a vertical manner, a horizontal manner, on an angle, etc.

Still further, implementations have been described above as using various visual effects to represent different scroll rates. In other implementations, various icons may be used to convey different scroll rates. For example, graphical icons depicting a turtle, a hare and a cheetah may be provided on display 130 to represent slow, medium and fast scrolling, respectively. In such instances, the user may select the graphical icon to scroll at a desired rate.

In addition, in some implementations, voice commands may be used to initiate scrolling at various rates or voice commands may be used to augment previously provided scroll-related inputs to change scrolling rates. For example, user device 100 may include voice recognition software that identifies words/phrases such as “faster,” “slower,” “medium scroll,” “stop,” etc. In these implementations, display control logic 320 may initiate scrolling based on the voice command and/or change a current scroll rate based on the voice command.

Further, while series of acts have been described with respect to FIGS. 4 and 6, the order of the acts may be varied in other implementations consistent with the invention. Moreover, non-dependent acts may be performed in parallel.

It will also be apparent to one of ordinary skill in the art that aspects of the invention, as described above, may be implemented, for example, in computer devices, cellular communication devices/systems, media playing devices, methods, and/or computer program products. Accordingly, aspects of the present invention may be embodied in hardware and/or in software (including firmware, resident software, micro-code, etc.). Furthermore, aspects of the invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, a microprocessor, an ASIC, an FPGA or other processing logic, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

The scope of the invention is defined by the claims and their equivalents.

What is claimed is:

1. A device, comprising:
a touch screen display configured to:
display at least a portion of a plurality of items, and
receive a first user input;
display configuration logic configured to:
configure the touch screen display to include at least two regions, each of the at least two regions being associated with a different scroll rate for scrolling the plurality of items, and
provide a visual indicator on the touch screen display, the visual indicator identifying a relative scroll rate associated with the at least two regions; and
display control logic configured to:
identify a location on the touch screen display corresponding to the first user input, and
control the scroll rate of the plurality of items based on the location.

2. The device of claim 1, wherein when controlling the scroll rate, the display control logic is configured to:
scroll the plurality of items, via the touch screen display, at a first rate when the identified location corresponds to a first location, and
scroll the plurality of items, via the touch screen display, at a second rate when the identified location corresponds to a second location, wherein the second scroll rate is faster than the first scroll rate.

3. The device of claim 1, wherein when providing a visual indicator, the display configuration logic is configured to:
provide at least one of a plurality of colors or a plurality of brightness levels associated with a background of the touch screen display to indicate a relative scroll rate associated with each of the at least two regions.

4. The device of claim 1, wherein when providing a visual indicator, the display configuration logic is configured to:
provide at least one of a shape, a line or a graphical icon to indicate a relative scroll rate associated with each of the at least two regions.

5. The device of claim 1, wherein the touch screen display is further configured to receive a second user input, and wherein the display control logic is further configured to:
change the scroll rate for scrolling the plurality of items based on a location of the second user input.

6. The device of claim 1, wherein when the second user input is located in a same one of the at least two regions as the first user input, the display control logic is further configured to:
increase the scroll rate associated with scrolling the plurality of items.

7. The device of claim 1, wherein the display configuration logic is configured to
provide a graphical user interface (GUI) configured to allow the user to at least one of:
select the at least two regions associated with different scroll rates, or
select the visual indicator for identifying the relative scroll rate associated with the at least two regions.

8. The device of claim 7, where the GUI is further configured to allow the user to at least one of:
select types of scrolling associated with different types of user inputs, or
select how scrolling rates will be modified for an input provided subsequent to the first user input.

9. The device of claim 1, wherein the display control logic is further configured to:
scroll, via the touch screen display, the plurality of items in response to the first user input, and
continue to scroll the plurality of items until a subsequent user input is detected.

10. The device of claim 1, wherein the device comprises a mobile terminal.

11. A method comprising:
outputting, to a display, at least a portion of a plurality of items;
receiving a first user input via the display;
identifying a location on the display corresponding to the first user input;
determining a scroll rate associated with the location; and
scrolling, via the display, the plurality of items at the determined scroll rate.

12. The method of claim 11, wherein the determining a scroll rate comprises:
determining a first scroll rate when the identified location corresponds to a first location, and
determining a second scroll rate when the identified location corresponds to a second location, wherein the second scroll rate is faster than the first scroll rate.

13. The method of claim 12, further comprising:
providing, via the display, a visual indicator identifying relative scroll rates associated with different portions of the display for scrolling the plurality of items.

14. The method of claim 13, wherein the providing a visual indicator comprises at least one of providing a color indicator or a brightness indicator to indicate relative scroll rates associated with the different portions of the display.

15. The method of claim 13, wherein the providing a visual indicator comprises at least one of providing a shape, a line or a graphical icon to indicate a relative scroll rate associated with the different portions of the display.

16. The method of claim 11, further comprising:
receiving user preference information associated with configuring regions of the display to correspond to different scroll rate input regions; and
receiving user preference information associated with providing a visual indicator associated with the different scroll rate input regions.

17. The method of claim 11, further comprising:
receiving user preference information associated with identifying different types of user inputs provided via the display, wherein the different types of user inputs include at least two of a touch, a flicking motion or a dragging motion;
identifying a type of user input corresponding to the first user input; and
scrolling the plurality of items based on the identified type of user input.

18. A computer-readable medium having stored thereon sequences of instructions which, when executed by at least one processor, cause the at least one processor to:
output, to a display, at least a portion of a plurality of items of interest;
receive, from the display, a first user input;
identify a location on the display corresponding to the first user input;
determine a scroll rate associated with the location; and
scroll, via the display, the plurality of items of interest at the determined scroll rate.

19. The computer-readable medium of claim 18, wherein the instructions for scrolling the plurality of items of interest cause the at least one processor to:
scroll, via the display, the plurality of items of interest at a first scroll rate when the identified location corresponds to a first side of the display, and
scroll, via the display, the plurality of items of interest at a second scroll rate when the identified location corresponds to a second side of the display, wherein the second scroll rate is faster than the first scroll rate.

20. The computer-readable medium of claim 18, further including instructions for causing the at least one processor to:
provide a graphical user interface configured to:
receive user preference information for selecting regions corresponding to different scroll rates, and
receive user preference information for selecting a visual indicator for indicating different relative scroll rates associated with the regions.
